(19) United States
(12) Patent Application Publication
(10) Pub. No.: US 2006/0257711 A1
(43) Pub. Date: Nov. 16, 2006

(54) Electrically conductive fluid distribution plate for fuel cells

(76) Inventors: Mahmoud H. Abd Elhamid, Grosse Ponte Woods, MI (US); Youssef M. Mikhail, Sterling Heights, MI (US); Daniel J. Lisi, Eastpointe, MI (US); Richard H. Blunk, Macomb Township, MI (US); Gayatri Vyas, Rochester Hills, MI (US); Michael K. Budinski, Pittsford, NY (US); Gerald W. Fly, Geneseo, NY (US); Timothy J. Fuller, Pittsford, NY (US); Brian K. Brady, North Chili, NY (US)

Correspondence Address: CARY W. BROOKS;General Motors Corporation, Mail Code 482-C23-B21, P.O. Box 300, Detroit, MI, 48265-3000, US

(21) Appl. No.: 11/127,374

(22) Filed: May 12, 2005

(51) Int. Cl. H01M 8/02; B32B 3/30

(52) U.S. Cl. 429/38; 428/167

(57) ABSTRACT

In at least one embodiment, the present invention provides an electrically conductive fluid distribution plate and a method of making, and system for using, the electrically conductive fluid distribution plate. The plate comprises a plate body having a surface defining a set of fluid flow channels configured to distribute flow of a fluid across at least one side of the plate, at least a portion of the surface having a roughness average of 0.5 to 5 μm and a contact resistance of less than 40 mohm cm² when sandwiched between carbon papers at 200 psi.

### FIELD OF THE INVENTION

The present invention relates generally to electrically conductive fluid distribution plate, a method of making an electrically conductive fluid distribution plate, and systems using an electrically conductive fluid distribution plate according to the present invention. More specifically, the present invention is related to the use of an electrically conductive fluid distribution plate in addressing contact resistance difficulties in fuel cells and other types of devices.

### BACKGROUND ART

Fuel cells are being developed as a power source for many applications including vehicular applications. One such fuel cell is the proton exchange membrane or PEM fuel cell. PEM fuel cells are well known in the art and include in each cell thereof a membrane electrode assembly or MEA. The MEA is a thin, proton-conductive, polymeric, membrane-electrolyte having an anode electrode face formed on one side thereof and a cathode electrode face formed on the opposite side thereof. One example of a membrane-electrolyte is the type made from ion exchange resins. An exemplary ion exchange resin comprises a perfluoronated sulfonic acid polymer such as NAFION™ available from the E.I. DuPont de Nemeours & Co. The anode and cathode faces, on the other hand, typically comprise finely divided carbon particles, very finely divided catalytic particles supported on the internal and external surfaces of the carbon particles, and proton conductive particles such as NAFION™ intermingled with the catalytic and carbon particles; or catalytic particles, without carbon, dispersed throughout a polytetrafluoroethylene (PTFE) binder.

Multi-cell PEM fuel cells comprise a plurality of the MEAs stacked together in electrical series and separated one from the next by a gas-impermeable, electrically-conductive fluid distribution plate known as a separator plate or a bipolar plate. Such multi-cell fuel cells are known as fuel cell stacks. The bipolar plate has two working faces, one confronting the anode of one cell and the other confronting the cathode on the next adjacent cell in the stack, and electrically conducts current between the adjacent cells. Electrically conductive fluid distribution plates at the ends of the stack contact only the end cells and are known as end plates. The bipolar plates contain a flow field that distributes the gaseous reactants (e.g. H₂ and O₂/air) over the surfaces of the anode and the cathode. These flow fields generally include a plurality of lands which define therebetween a plurality of flow channels through which the gaseous reactants flow between a supply header and an exhaust header located at opposite ends of the flow channels.

A highly porous (i.e. ca. 60%-80%), electrically-conductive material (e.g. cloth, screen, paper, foam, etc.) known as “diffusion media” is generally interposed between electrically conductive fluid distribution plates and the MEA and serves (1) to distribute gaseous reactant over the entire face of the electrode, between and under the lands of the electrically conductive fluid distribution plate, and (2) collects current from the face of the electrode confronting a groove, and conveys it to the adjacent lands that define that groove. One known such diffusion media comprises a graphite paper having a porosity of about 70% by volume, an uncompressed thickness of about 0.17 mm, and is commercially available from the Toray Company under the name Toray 060. Such diffusion media can also comprise fine mesh, noble metal screen and the like as is known in the art.

In an H₂—O₂/air PEM fuel cell environment, the electrically conductive fluid distribution plates can typically be in constant contact with mildly acidic solutions (pH 3-5) containing F⁻, SO₄⁻⁻, SO₃⁻, HSO₄⁻, CO₃⁻⁻ and HCO₃⁻, etc. Moreover, the cathode typically operates in a highly oxidizing environment, being polarized to a maximum of about +1 V (vs. the normal hydrogen electrode) while being exposed to pressurized air. Finally, the anode is typically constantly exposed to hydrogen. Hence, the electrically conductive fluid distribution plates should be resistant to a hostile environment in the fuel cell.

One of the more common types of suitable electrically conductive fluid distribution plates includes those molded from polymer composite materials which typically comprise about 50% to about 90% by volume electrically-conductive filler (e.g. graphite particles or filaments) dispersed throughout a polymeric matrix (thermoplastic or thermoset). Recent efforts in the development of composite electrically conductive fluid plates have been directed to materials having adequate electrical and thermal conductivity. Material suppliers have developed high carbon loading composite plates comprising graphite powder in the range of 50% to 90% by volume in a polymer matrix to achieve the requisite conductivity targets. Plates of this type will typically be able to withstand the corrosive fuel cell environment and, for the most part, meet cost and conductivity targets. One such currently available bipolar plate is available as the BMC plate from Bulk Molding Compound, Inc. of West Chicago, Ill.

Alternatively, discrete conductive fibers have been used in composite plates in an attempt to reduce the carbon loading and to increase plate toughness. See copending U.S. Pat. No. 6,607,857 to Blunk, et. al., issued Aug. 19, 2003, which is assigned to the assignee of this invention, and is incorporated herein by reference. Fibrous materials are typically ten to one thousand times more conductive in the axial direction as compared to conductive powders. See U.S. Pat. No. 6,827,747 to Lisi, et. al., issued Dec. 7, 2004, which is assigned to the assignee of the present invention and is incorporated herein by reference.

As part of the manufacturing process, the surfaces of the molded composite plates are typically lightly scuffed with sandpaper to remove what is commonly called the skin layer to make the surface more conductive. These scuffed surfaces typically have a roughness average of 0.1-0.2 μm.

Another one of the more common types of suitable electrically conductive fluid distribution plates include those made of metal. A relatively common approach to using metal plates has been to coat lightweight metal electrically conductive fluid distribution plates with a layer of metal or metal compound, which is both electrically conductive and corrosion resistant to thereby protect the underlying metal. In this regard, stainless steel has always been an attractive base layer material for electrically conductive fluid distribution plates because of its relatively low cost and its excellent corrosion resistance. However, a conductive coating has still typically been employed to reduce the contact resistance on its surface, thereby negating some of the advantage of using a relatively inexpensive material.

One example of a coated metal plate is disclosed in Li et al RE 37,284E, issued Jul. 17, 2001, which (1) is assigned to the assignee of this invention, (2) is incorporated herein by reference, and (3) discloses a lightweight metal core, a stainless steel passivating layer atop the core, and a layer of titanium nitride (TiN) atop the stainless steel layer. Other types of coatings that are used to lower the contact resistance of the surface of metal plates, include relatively costly materials such as gold and its alloys.

As discussed above, a great percentage of the electrically conductive fluid distribution plates comprises either a composite polymeric material or a metallic base layer. Each of these types of plates typically requires additional steps that contribute to the time and cost to manufacture these plates. Thus, there is a desire to provide an electrically conductive fluid distribution plate that has low contact resistance and is economically efficient to produce.

### SUMMARY OF THE INVENTION

In at least one embodiment, an electrically conductive fluid distribution plate is provided comprising a plate body having a surface defining a set of fluid flow channels configured to distribute flow of a fluid across at least one side of the plate, with at least a portion of the surface having a roughness average of greater than 0.5 μm and a contact resistance of less than 40 mohm cm² at 200 psi when sandwiched between carbon papers.

In yet another embodiment, a method of manufacturing an electrically conductive fluid distribution plate is provided comprising providing an electrically conductive fluid distribution plate body having a surface defining a set of fluid flow channels configured to distribute flow of a fluid across at least one side of the plate, the surface having a first roughness average of less than 0.25 μm, and exposing the surface to a solid media under conditions to render at least a portion of the surface with a second roughness average of greater than 0.5 μm, and a contact resistance of less than 40 mohm cm² at 200 psi when sandwiched between carbon papers.

In still yet another embodiment, a fuel cell is provided. The fuel cell includes a first electrically conductive fluid distribution plate including a plate body having a surface defining a set of fluid flow channels configured to distribute flow of a fluid across at least one side of the plate. At least a portion of the surface has a roughness average of greater than 0.5 μm and a contact resistance of less than 40 mohm cm² when sandwiched between carbon papers at 200 psi. The fuel cell further includes a second electrically conductive fluid distributing plate, and a membrane electrode assembly separating the first electrically conductive fluid distribution plate and the second electrically conductive fluid distribution plate. The membrane electrode assembly includes an electrolyte membrane having a first side and a second side, an anode adjacent to the first side of the electrolyte membrane, and a cathode adjacent to the second side of the electrolyte membrane.

The present invention will be more fully understood from the following description of preferred embodiments of the invention taken together with the accompanying drawings. It is noted that the scope of the claims is defined by the recitations therein and not by the specific discussion of features and advantages set forth in the present description.

### BRIEF DESCRIPTION OF THE DRAWINGS

The following detailed description of the embodiments of the present invention can be best understood when read in conjunction with the following drawings, where like structure is indicated with like reference numerals and in which:

FIG. 1 is a schematic illustration of a vehicle including a fuel cell system;

FIG. 2 is a schematic illustration of a fuel cell stack employing two fuel cells;

FIG. 3 is an illustration of an electrically conductive fluid distribution plate according to one embodiment of the present invention;

FIG. 4 is an illustration of an electrically conductive fluid distribution plate according to another embodiment of the present invention; and

FIGS. 5 and 6 are polarization graphs portraying cell voltage current density and contact resistance achieved by sandblasted stainless steel of the present invention in comparison to an un-sandblasted stainless steel and a gold coated stainless steel.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE PREFERRED EMBODIMENTS

The following description of the preferred embodiments is merely exemplary in nature and is in no way intended to limit the invention, its application, or uses. Reference will now be made in detail to presently preferred compositions, embodiments and methods of the present invention, which constitute the best modes of practicing the invention presently known to the inventors. The figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for the claims and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of”, and ratio values are by weight; the term “polymer” includes “oligomer”, “copolymer”, “terpolymer”, and the like; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and to normal grammatical variations of the initially defined abbreviation; and, unless expressly stated to the contrary, measurement of a property is determined by the same technique as previously or later referenced for the same property.

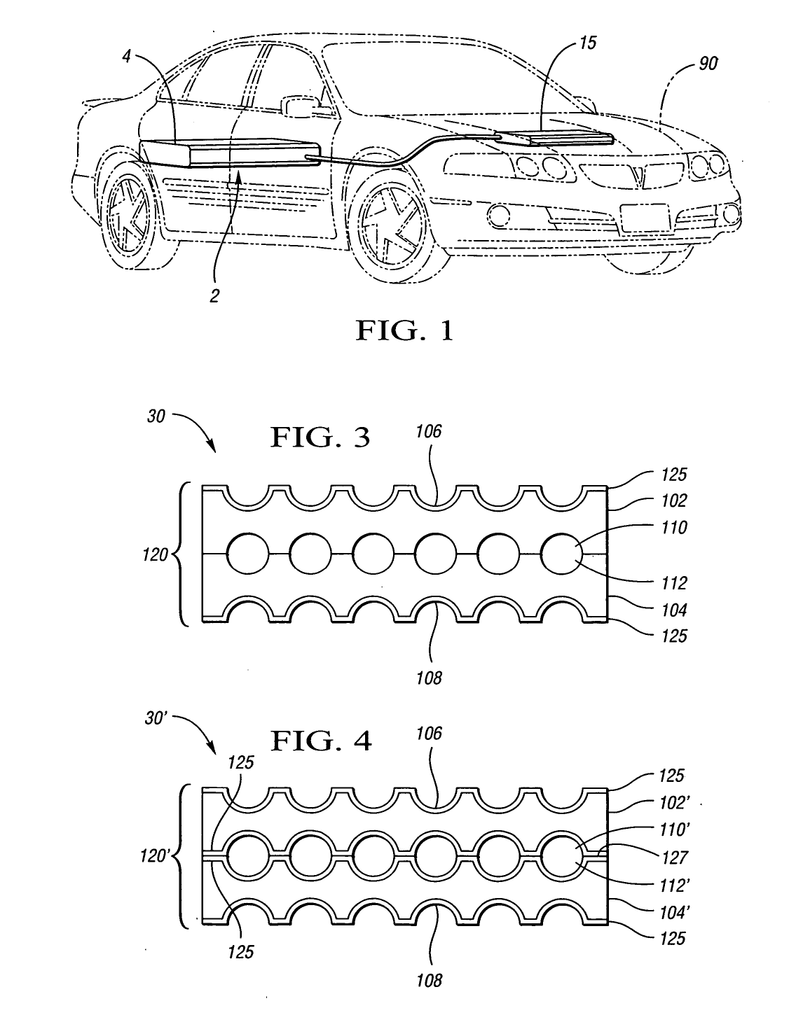

Referring to FIG. 1, an exemplary fuel cell system 2 for automotive applications is shown. It is to be appreciated, however, that other fuel cell system applications, such as for example, in the area of residential systems, may benefit from the present invention.

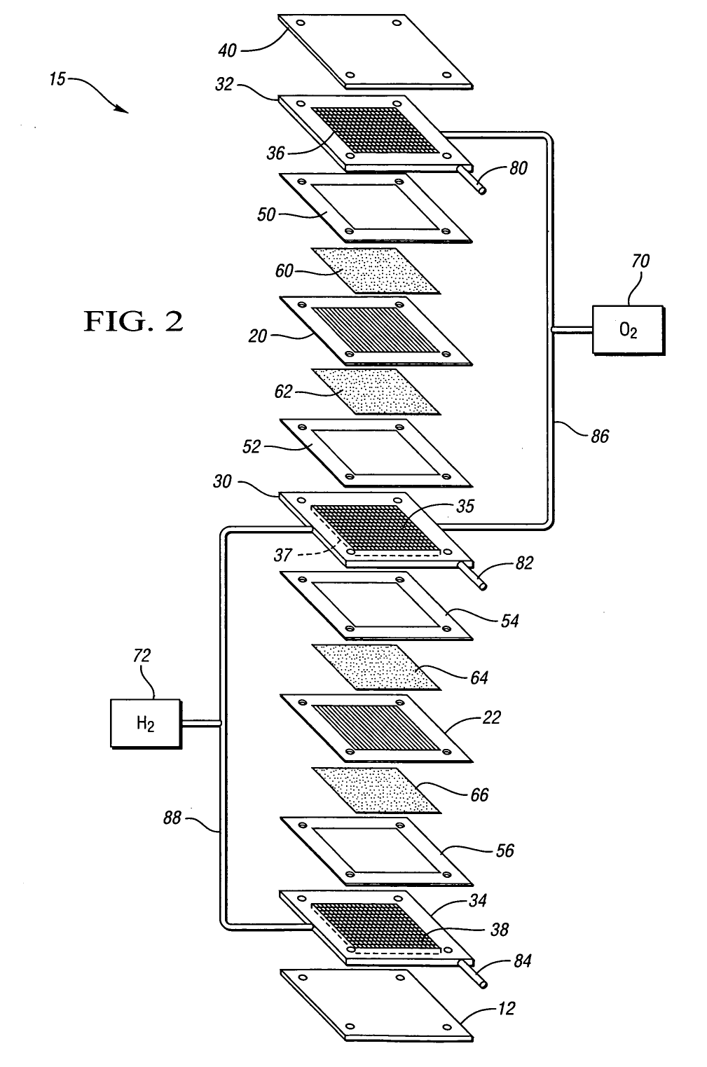

In the embodiment illustrated in FIG. 1, a vehicle is shown having a vehicle body 90, and an exemplary fuel cell system 2 having a fuel cell processor 4 and a fuel cell stack 15. A discussion of embodiments of the present invention as embodied in a fuel cell stack and a fuel cell, is provided hereafter in reference to FIGS. 2-6. It is to be appreciated that while one particular fuel cell stack 15 design is described, the present invention may be applicable to any fuel cell stack designs where fluid distribution plates have utility.

FIG. 2 depicts a two fuel cell, fuel cell stack 15 having a pair of membrane-electrode-assemblies (MEAs) 20 and 22 separated from each other by an electrically conductive fluid distribution plate 30. Plate 30 serves as a bi-polar plate having a plurality of fluid flow channels 35, 37 for distributing fuel and oxidant gases to the MEAs 20 and 22. By “fluid flow channel” we mean a path, region, area, or any domain on the plate that is used to transport fluid in, out, along, or through at least a portion of the plate. The MEAs 20 and 22, and plate 30, may be stacked together between clamping plates 40 and 42, and electrically conductive fluid distribution plates 32 and 34. In the illustrated embodiment, plates 32 and 34 serve as end plates having only one side containing channels 36 and 38, respectively, for distributing fuel and oxidant gases to the MEAs 20 and 22, as opposed to both sides of the plate.

Nonconductive gaskets 50, 52, 54, and 56 may be provided to provide seals and electrical insulation between the several components of the fuel cell stack. Gas permeable carbon/graphite diffusion papers 60, 62, 64, and 66 can press up against the electrode faces of the MEAs 20 and 22. Plates 32 and 34 can press up against the carbon/graphite papers 60 and 66 respectively, while the plate 30 can press up against the carbon/graphite paper 64 on the anode face of MEA 20, and against carbon/graphite paper 60 on the cathode face of MEA 22.

In the illustrated embodiment, an oxidizing fluid, such as O₂, is supplied to the cathode side of the fuel cell stack from storage tank 70 via appropriate supply plumbing 86. While the oxidizing fluid is being supplied to the cathode side, a reducing fluid, such as H₂, is supplied to the anode side of the fuel cell from storage tank 72, via appropriate supply plumbing 88. Exhaust plumbing (not shown) for both the H₂ and O₂/air sides of the MEAs will also be provided. Additional plumbing 80, 82, and 84 is provided for supplying liquid coolant to the plate 30 and plates 32 and 34. Appropriate plumbing for exhausting coolant from the plates 30, 32, and 34 is also provided, but not shown.

FIG. 3 illustrates an exemplary electrically conductive fluid distribution plate 30 comprising a first sheet 102 and a second sheet 104. First and second sheets 102, 104 comprise a plurality of fluid flow channels 106, 108 on their exterior sides/surfaces through which the fuel cell's reactant gases flow typically in a tortuous path along one side of each plate. The interior sides of the first and second sheets 102, 104 may include a second plurality fluid flow channels 110, 112 through which coolant passes during the operation of the fuel cell. When the interior sides of first sheet 102 and second sheet 104 are placed together to form a plate body 120, the fluid flow channels connect and form a series of channels for coolant to pass through the plate 30.

The plate body 120 may be formed from a single sheet, or plate, rather than the two separate sheets illustrated in FIG. 3. When the plate body 120 is formed from a single plate, the channels may be formed on the exterior sides of the plate body 120 and through the middle of the plate body 120 such that the resulting plate body 120 is equivalent to the plate body 120 configured from two separate sheets 102, 104.

The plate body 120 may be formed from a metal, a metal alloy, or a composite material, and has to be conductive. Suitable metals, metal alloys, and composite materials should be characterized by sufficient durability and rigidity to function as a fluid distribution plate in a fuel cell. Additional design properties for consideration in selecting a material for the plate body include gas permeability, conductivity, density, thermal conductivity, corrosion resistance, pattern definition, thermal and pattern stability, machinability, cost and availability

. Available metals and alloys include titanium, stainless steel, nickel based alloys, and combinations thereof. Composite materials may comprise graphite, graphite foil, graphite particles in a polymer matrix, carbon fiber paper and polymer laminates, conductively coated polymer plates, and combinations thereof.

First and second sheets 102, 104 are typically between about 51 to about 510 μm (microns) thick. The sheets 102, 104 may be formed by machining, molding, cutting, carving, stamping, photo etching such as through a photolithographic mask, or any other suitable design and manufacturing process. It is contemplated that the sheets 102, 104 may comprise a laminate structure including a flat sheet and an additional sheet including a series of exterior fluid flow channels. An interior metal spacer sheet (not shown) may be positioned between the first and second sheets 102, 104.

In at least one embodiment, the electrically conductive fluid distribution plate 30 has a surface portion 125 having a roughness average (Ra) of at least 0.5 μm, in another embodiment between 0.5 to 50 μm, in yet another embodiment between 0.75 and 25 μm, in yet another embodiment between 0.90 and 10 μm, and in still yet another embodiment between 1.0 and 5 μm. The roughness average can be measured using WYKO surface profilers made by WYKO Corporation, Tuscon, Ariz. The WYKO surface profiler systems use non-contact optical interferometry to obtain surface smoothness/roughness by recording the intensity of interference patterns. One suitable profiler is the 980-005 WYKO profiler. One set of suitable test set-up parameters includes size: 348 μm×240 μm; sampling: 1.45 μm; terms removed: cylinder & tilt; and filtering: low pass.

Applicants have found that providing an electrically conductive distribution plate 30 having a surface portion 125 having a roughness average in at least one of the above ranges can result in an electrically conducted distribution plate having excellent contact resistance without the use of a low contact resistance coating. While surface portion 125 can extend over substantially the entire outer surface of plate 30, as schematically illustrated in FIG. 3, the surface portion 125 can also extend over less than the entire outer surface.

Applicants have also found that providing an electrically conductive distribution plate 30 having a surface portion 125 having a peak density along the X direction (Stylus XPc) of at least 8 peaks/mm can result in an electrically conductive distribution plate having excellent contact resistance without the use of a low contact resistance coating. In at least one embodiment, the surface portion 125 has a peak density (Stylus XPc) of 8-25 peaks/mm, and in yet another embodiment between 12-18 peaks/mm. In at least one embodiment, the surface portion 125 is substantially isotropic. The peak density (Stylus XPc) can be measured using a WYKO surface profiler. A peak is defined as when the profile intersects consecutively a lower and upper boundary level set at a height above a depth below the mean line, equal to Ra for the profile being analyzed.

Applicants have also found that providing an electrically conductive distribution plate 30 having a surface portion 125 having an average maximum profile height (Rz) of at least 7 μm can result in an electrically conductive distribution plate having excellent contact resistance without the use of a low contact resistance coating. In at least one embodiment, the average maximum profile height (Rz) is 7-25 μm, and in yet another embodiment 10-18 μm. The average maximum profile height can be measured using a WYKO surface profiler. The average maximum profile height is the difference between the average of the 10 highest peaks and the average of the 10 lowest valleys.

The excellent contact resistance properties of the plate 30 can be appreciated as a result of low contact resistance of the surface portion 125 of the plate 30 made in accordance with the present invention. In at least one embodiment, the surface portion 125 of the electrically conductive fluid distribution plate 30 made in accordance with the present invention may exhibit a contact resistance of less than 40 mohm cm² when sandwiched between carbon paper at a contact pressure of 200 psi, in other embodiments between 5 and 40 mohm cm², and in other embodiments between 10 and 30 mohm cm².

The electrically conductive fluid distribution plate 30 of the present invention can be made by exposing the surface of the plate 30 to a solid roughening media under conditions to result in a roughness average of the surface portion 125 of plate 30 as discussed above. The roughness average of the surface of a conventional plate is typically below 0.2 μm. The average peak density (Stylus XPc) of the surface of a conventional plate is typically below 4.5 peaks/mm. The average maximum profile height of a conventional plate is typically below 3 μm.

Any suitable solid roughening medias can be used to suitably roughen the desired surface(s) of the plate 30. Suitable solid medias can include sand, soda, plastic pellets, alumina, zirconium, and glass, etc. In at least one embodiment, suitable solid medias can have an average diameter (particle size) of 0.5 to 25 μm, and in another embodiment of 1 to 10 μm. The pressure and time that the solid media will be exposed to the plate 30 can vary as needed. However, it is anticipated that average pressures of 5 to 75 psi for a time period of 0.15 to 5 minutes are likely to find utility. In at least one embodiment, the surface of the electrically conductive fluid distribution plate 30 of the present invention can be reduced in thickness by the roughening relative to their pre-roughened state by 0.05-0.5 μm.

As set forth above, the plate 30 of the present invention can be made of any suitable material. However, in at least one embodiment, to take advantage of its relatively low cost and relatively high availability, a stainless steel metal plate 30 is preferred. Due to the excellent contact resistance obtained by metal plates 30 made in accordance with the present invention, metal plates 30 of the present invention do not require a separate low contact resistance coating. Any grade stainless steel can find suitable applicability when used with membranes that tend not to leach applicable levels of fluoride ions, such as hydrocarbon membranes.

In environments where corrosion tends to be more of an issue, such as with membranes that leach appreciable levels of fluoride ions, such as NAFION™ membranes, applicants have found relatively high grades of stainless steel/alloys to be particularly suitable in yielding a plate 30 having high corrosion resistance and good contact resistance. In at least one embodiment, higher grades of stainless steel/alloys are defined as stainless steels and alloys having a combined content of molybdenum, chromium, and nickel that is greater than at least 40% by weight of the total weight of the stainless steel, in another embodiment greater than 50% and in another embodiment greater than 60%. Suitable examples of higher grades of stainless steel include, but are not necessarily limited to Inconel® 601, 904L, 254 SMO®, AL6XN®, Carp-20, C276 and others. When higher grades of stainless steel are used, the surface portion 125 of the plate 30 of the present invention, in at least one embodiment, may have a corrosion resistance of less than 100 nA/cm², and a contact resistance of less than 30 mohm cm² when sandwiched between carbon paper at a contact pressure of 200 psi, in other embodiments between 5 and 30 mohm cm², and in yet other embodiments between 10 and 25 mohm cm².

FIG. 4 illustrates another embodiment of the present invention. The plate 30′ and the body 120′ illustrated in FIG. 4 are similar in construction and use as the plate 30 and the body illustrated in FIG. 3. Parts of the plate 30′ that are substantially the same as the corresponding parts in the plate 30 illustrated in FIG. 3 are given the same reference numeral and parts of the plate 30′ that are substantially different than the corresponding parts in the plate 30 are given the same part number with the suffix added for clarity.

In at least one embodiment, as schematically illustrated in FIG. 4, the interior sides of the first and second sheets 102′ and 104′ of plate 30′ can also have opposed surface portions 125 roughened in the same manner as those on the exterior surfaces in FIG. 3. In the embodiment illustrated in FIG. 4, the opposed surface portions 125 of the plate 30′ meet at contact point 127. In at least one embodiment, no bonding adhesive is needed at contact point 127. Applicants have found that providing an electrically conductive distribution plate 30′ having opposed surface portions 125 having a roughness average in at least one of the above ranges can result in an electrically conductive distribution plate having excellent contact resistance at 127 across stacked sheets (i.e., plate-to-plate), even without joint bonding adhesive. In at least one embodiment, the electrically conductive fluid distribution plate 30′ made in accordance with the present invention may exhibit a resistance across the sides 102′ and 104′ of the plate 30′ of less than 5 mohm cm² at a contact pressure of 200 psi, in other embodiments between 0.1 and 4 mohm cm², in other embodiments between 0.25 and 3 mohm cm², and in other embodiments between 0.5 and 2.5 mohm cm².

An electrically conductive fluid distribution plate according to the various embodiments of the present invention has excellent contact resistance without requiring any low contact resistance coating. Moreover, the electrically conductive fluid distribution plate costs relatively little to manufacture and can be manufactured without any plate-to-plate or joint bonding adhesive. It should be understood that the principles of the present invention apply equally as well to unipolar plates and bipolar plates.

The present invention will be further explained by way of examples. It is to be appreciated that the present invention is not limited by the examples.

### EXAMPLES

Various metal substrates having a thickness of 2 mm are sandblasted with a sand based media having an average particle size of 1 to 10 μm at a pressure of 50 psi for a time period of 10-25 seconds. After sandblasting, the substrates have a roughness average (Ra) of above 1 μm, a peak density along the X direction (Stylus XPc) of above 13 peaks/mm, and an average maximum profile height (Rz) of above 13 μm.

Table 1 below shows the alloy and the contact resistance of the alloy prior to sandblasting (i.e., “as is”) and after sandblasting.

TABLE 1

| | | | Plate-to-Plate | Plate-to-Plate |
|---|---|---|---|---|
| | As is | Sandblasted | As Is | Sandblasted |
| Alloy | (mohm cm²) | (mohm cm²) | (mohm cm²) | (mohm cm²) |
| 316L | 270 | 38 | >50 | 2.2 |
| 601 | 21 | 16.0 | >50 | 2.5 |
| 904L | 133 | 26.6 | >50 | 2.4 |
| AL6XN | 215 | 26.6 | >50 | 2.7 |
| C-276 | 161 | 18.6 | >50 | 1.6 |

Table 1 shows that the contact resistance at the surface and the joint (plate-to-plate) are reduced significantly after sandblasting the samples. Furthermore, this table also shows that the higher grades of stainless steel have lower contact resistance than 316L.

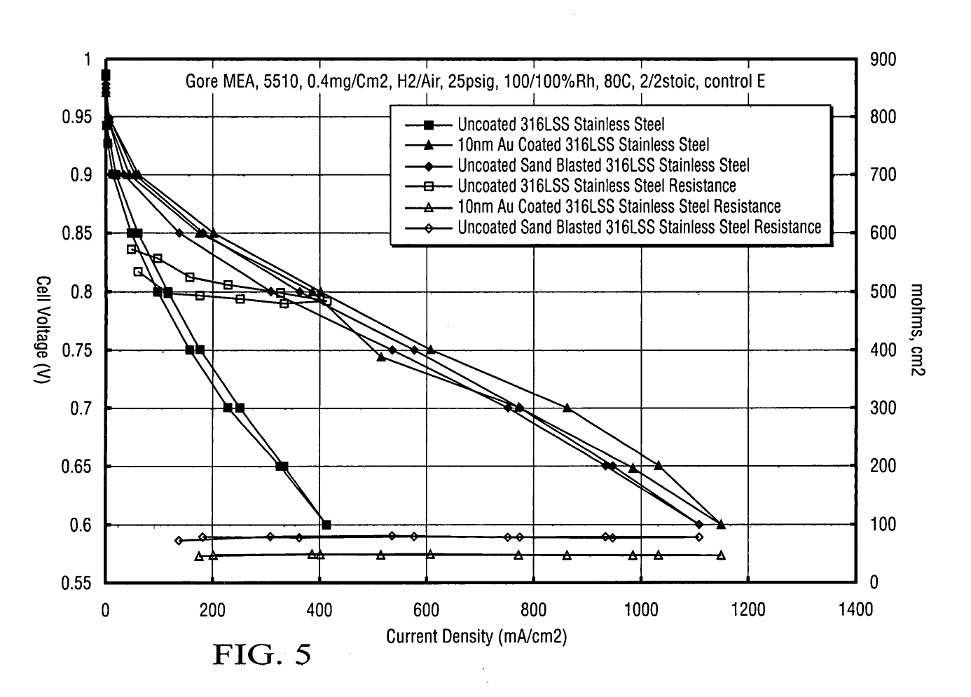

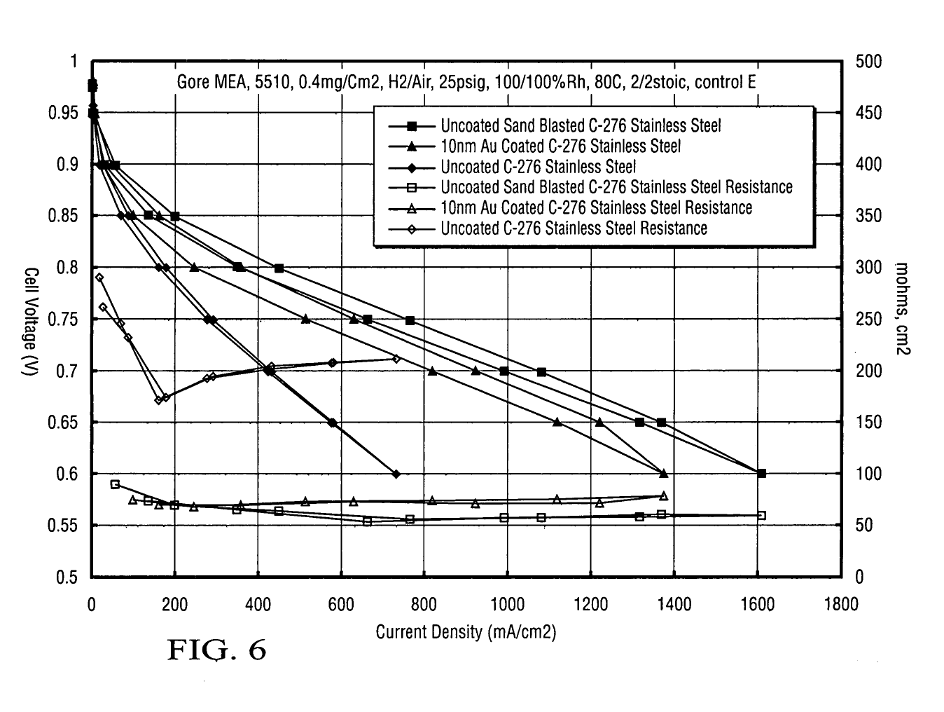

FIGS. 5-6 are graphs showing the contact resistance of various substrates. The effects of the present invention on contact resistance and cell voltage are shown in FIG. 5. FIG. 5 is a graph depicting a comparison of a 316L stainless steel substrate coated with 10 nm Au, an uncoated 316L stainless steel substrate, and an uncoated 316L stainless steel sandblasted in accordance with the present invention. As can be seen in FIG. 5, the uncoated 316L stainless steel sandblasted in accordance with the present invention provides a distinct advantage in cell voltage and contact resistance over an uncoated stainless steel substrate. In comparison to a 316L stainless steel substrate coated with 10 nm Au, the uncoated 316L stainless steel sandblasted in accordance with the present invention provides a cell voltage and contact resistance that are substantially the same.

FIG. 6 is a graph depicting a comparison of a C-276 stainless steel substrate coated with 10 nm Au, an uncoated C-276 stainless steel substrate, and an uncoated C-276 stainless steel sandblasted in accordance with the present invention. As can be seen in FIG. 6, the uncoated C-276 stainless steel sandblasted in accordance with the present invention provides a distinct advantage in cell voltage and contact resistance over an uncoated stainless steel substrate. In comparison to a C-276 stainless steel substrate coated with 10 nm Au, the uncoated C-276 stainless steel sandblasted in accordance with the present invention provides a cell voltage and contact resistance that are substantially the same.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed:

1. An electrically conductive fluid distribution plate comprising:
a plate body having a surface defining a set of fluid flow channels configured to distribute flow of a fluid across at least one side of the plate, at least a portion of the surface having a roughness average of greater than 0.5 μm, and a contact resistance of less than 40 mohm cm² when sandwiched between carbon papers at 200 psi.

2. The plate of claim 1 wherein the roughness average of the surface portion is 0.5 to 50 μm.

3. The plate of claim 2 wherein the contact resistance is 5 to 40 mohm cm² when sandwiched between carbon paper at 200 psi.

4. The plate of claim 1 wherein the plate body comprises a metallic surface.

5. The plate of claim 4 wherein the plate body comprises a high quality stainless steel having a combined content of molybdenum, chromium, and nickel greater than 40% by weight of the total weight of the stainless steel.

6. The plate of claim 5 wherein the contact resistance is 5 to 30 mohm cm² when sandwiched between carbon papers at 200 psi.

7. The plate of claim 1 wherein the plate body comprises a composite polymeric surface.

8. The plate of claim 1 wherein the plate comprises a bipolar plate comprising opposed sheets having a contact resistance across the sheets of the bipolar plate of 0.1 to 4 mohm cm² at 200 psi.

9. The plate of claim 1 wherein the plate comprises a unipolar plate.

10. The plate of claim 1 wherein the surface was roughened by a solid media under conditions to obtain the roughness average of greater than 0.5 μm.

11. The plate of claim 2 wherein the surface portion has a peak density of at least 8 peaks/mm along the X direction, an average maximum profile height of at least 7 μm, and a contact resistance of less than 30 mohm cm² when sandwiched between carbon papers at 200 psi; and
the plate body comprising high quality stainless steel having a combined content of molybdenum, chromium, and nickel of greater than 40% by weight of the total weight of the stainless steel.

12. A method of manufacturing a fluid distribution plate comprising:
providing a plate body having a surface defining a set of fluid flow channels configured to distribute flow of a fluid across at least one side of the plate, the surface having a first roughness average of less than 0.2 μm; and
exposing the surface to a solid media under conditions to provide at least a portion of the surface with a second roughness average of greater than 0.5 μm, and a contact resistance of less than 40 mohm cm² when sandwiched between carbon papers at 200 psi.

13. The method of claim 12 wherein solid media is exposed to the surface at an average pressure of 5-75 psi and for a period of 0.15 to 5 minutes.

14. The method of claim 13 wherein the solid media has an average diameter of 0.5-25 μm.

15. The method of claim 14 wherein the solid media comprises sand.

16. The method of claim 12 wherein the contact resistance is 5 to 40 mohm cm² when sandwiched between carbon paper at 200 psi.

17. The method of claim 12 wherein the plate body comprises a high quality stainless steel having a combined content of molybdenum, chromium, and nickel greater than 40% by weight of the total weight of the stainless steel.

18. The method of claim 17 wherein the contact resistance is 5 to 30 mohm cm² when sandwiched between carbon papers at 200 psi.

19. The method of claim 12 wherein the plate body comprises a composite polymeric surface and a bipolar plate comprising opposed sheets, the resistance across the sheets of the bipolar plate being 0.1 to 4 mohm cm² at 200 psi.

20. A fuel cell comprising:
a first electrically conductive fluid distribution plate comprising a plate body having a surface defining a set of fluid flow channels configured to distribute flow of a fluid across at least one side of the plate, at least a portion of the surface having a roughness average of greater than 0.5 μm and a contact resistance of less than 40 mohm cm² when sandwiched between carbon papers at 200 psi;
a second electrically conductive fluid distributing plate; and
a membrane electrode assembly separating the first electrically conductive fluid distribution plate and the second electrically conductive fluid distribution plate, the membrane electrode assembly comprising:
an electrolyte membrane, having a first side and a second side, an anode adjacent to the first side of the electrolyte membrane; and
a cathode adjacent to the second side of the electrolyte membrane.
